(19) United States
(12) Patent Application Publication
(10) Pub. No.: US 2016/0148490 A1
(43) Pub. Date: May 26, 2016

(54) RAPID RESPONSE WITH DIRECT CONNECT FOR EMERGENCY RESPONDERS

(71) Applicants: John Preston BARNES, Sparta, MI (US); Kevin Wayne BARNES, Flat Rock, MI (US)

(72) Inventors: John Preston BARNES, Sparta, MI (US); Kevin Wayne BARNES, Flat Rock, MI (US)

(21) Appl. No.: 14/948,643

(22) Filed: Nov. 23, 2015

Related U.S. Application Data
(60) Provisional application No. 62/123,653, filed on Nov. 24, 2014.

(51) Int. Cl. G08B 25/01; H04W 4/22; H04M 1/725; G08B 27/00

(52) U.S. Cl. CPC G08B 25/016; G08B 27/001; H04W 4/22; H04M 1/72563

(57) ABSTRACT

A smart phone app system for use by emergency responders, includes a server for processing and sending an alert signal indicating details of an emergency event to be displayed on an emergency responder's smart phone or other device and displaying input buttons for allowing the emergency responder to provide a response signal indicating that they are responding or they are not responding by touching one of the input buttons. A map to the station or emergency site can be automatically displayed on the emergency responder's smart phone or other device and a list of other responders can be displayed with direct text or other communication being available to the other responders with a simple press of a button. The app system greatly improves the response time and efficiency for responding to an emergency event.

### CROSS-REFERENCE TO RELATED APPLICATIONS

This application claims the benefit of U.S. Provisional Application No. 62/123,653, filed on Nov. 24, 2014. The entire disclosure of the above application is incorporated herein by reference.

### FIELD

The present disclosure relates to an app for use with smart phones and the like to allow direct communication between emergency dispatchers and emergency responders for accelerated response to emergency situations.

### BACKGROUND AND SUMMARY

This section provides background information related to the present disclosure which is not necessarily prior art.

In emergency situations, calls are commonly placed to emergency dispatchers who assess the emergency situation and dispatch emergency personnel to the scene of the emergency. The emergency situation may involve an accident, a medical condition, a fire, a crime scene or one of numerous other situations where time may be of the essence to save a life, prevent further injury, protect property or to catch a fleeing suspect.

By way of example, in the case of a fire emergency, both professional and volunteer firefighters may be called upon to respond to the emergency call. Fire fighters fall into three categories, career, part paid and volunteer, all of which are professionals. Part paid fire fighters make up the majority of fire fighters throughout the U.S. In a typical situation, a fire alarm is signaled and volunteer firefighters from around the community may travel to the local fire station, grab any necessary gear and climb aboard a fire truck or other response vehicle to go to the scene of the fire. A fire chief or other coordinator needs to assess whether an adequate number of firefighters are responding to the alarm. Otherwise they call for additional help from either other stations in their district or neighboring fire departments. This process can use up critical time as the crew waits for sufficient manpower for responding to the fire.

There are numerous computer aided dispatching systems which allow a dispatcher to enter call data that is then exported. The dispatcher is able to put out radio transmissions and some dispatching systems have the ability to send data out via text, e-mail or fax.

The present disclosure provides an app that allows superior emergency services coordination to allow emergency responders to be alerted of the nature of an emergency call as soon as the call is processed. The app allows each emergency responder to select and transmit their availability status (e.g. responding, responding directly to the emergency site with equipment, or not responding) all at a touch of a button. Based upon that information, a fire chief or other response coordinator will have instant feedback as to which responders are coming to the station and which responders are going directly to the site of the emergency. The app may provide the response coordinator with the precise location, in real time, of every member of the team by showing on a map who is responding and where they are. This allows the coordinator to make important split second decisions, e.g. whether to leave the fire station or to wait moments longer for nearby team members to arrive. The app can also provide responders with the best up-to-date routes and up-to the minute traffic information for getting to an emergency site. The app can also provide critical information for locating the nearest fire hydrants as the responders arrive at an emergency site thereby ensuring optimal results.

The app may also provide the response coordinator with information regarding whether additional sets of equipment may need to be transported to the emergency site for those who are responding directly to the site but who do not have equipment with them. The app also provides emergency responders with all pertinent details of the emergency situation and additional updates of the details are uploaded as they become available allowing responders to provide the best response. By way of example, an initial report of a victim drowning in a pool at an apartment complex can be followed up with the specific location of the pool so that responders do not lose valuable time locating the pool.

The app according to the present disclosure is implemented using existing smart phone technology and taps into existing map, text communication and other apps for improved emergency responder communication that can greatly assist with fire, medical and law enforcement response teams. The app of the present disclosure receives the dispatchers exported data and deciphers the call information that the computer aided dispatcher system puts out. It automatically interprets the data about the call and supplies it directly to the end user including placing the address information directly into the user's map display, instantly allowing the user to reply whether and how they are responding, and allowing direct user to user communication without having to pull up contacts, etc. All of these features provide unique integration and automation that allow for vastly improved emergency coordination and response.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a diagramatic illustration of the features of the app system according to the principles of the present disclosure; and

FIG. 2 is a diagram showing the server and user devices for use with the app system of the present disclosure.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

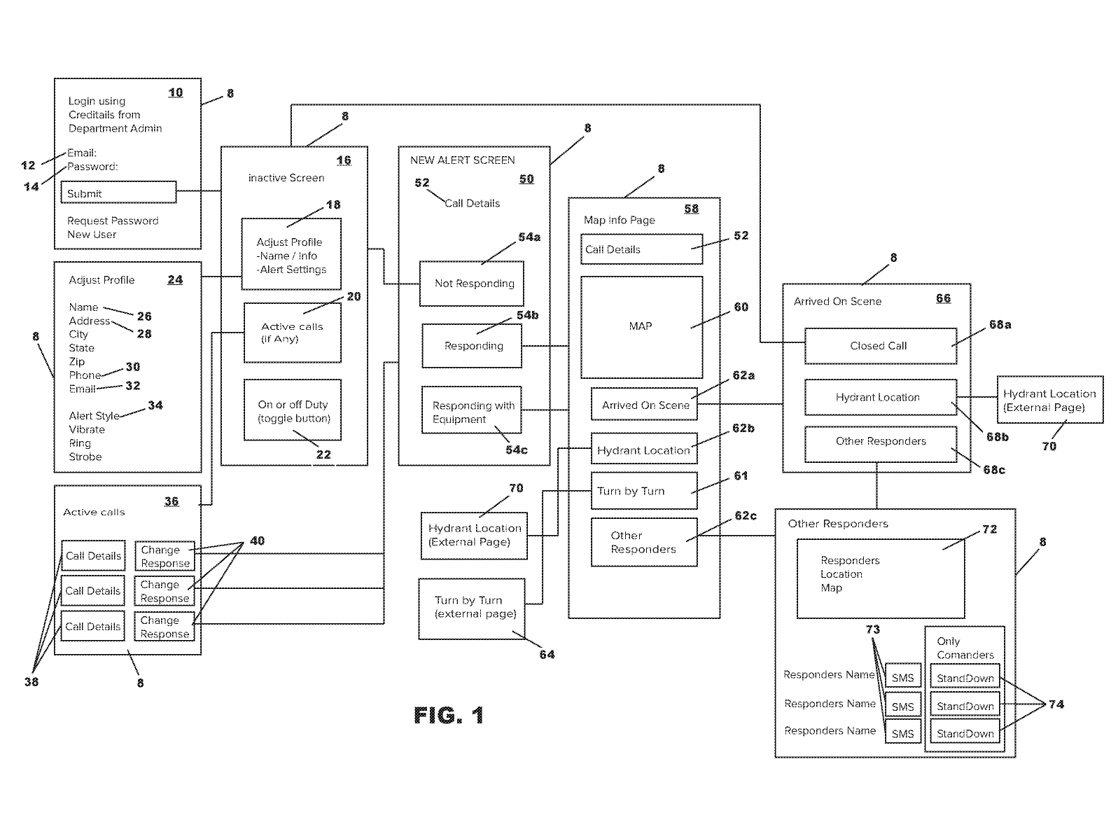

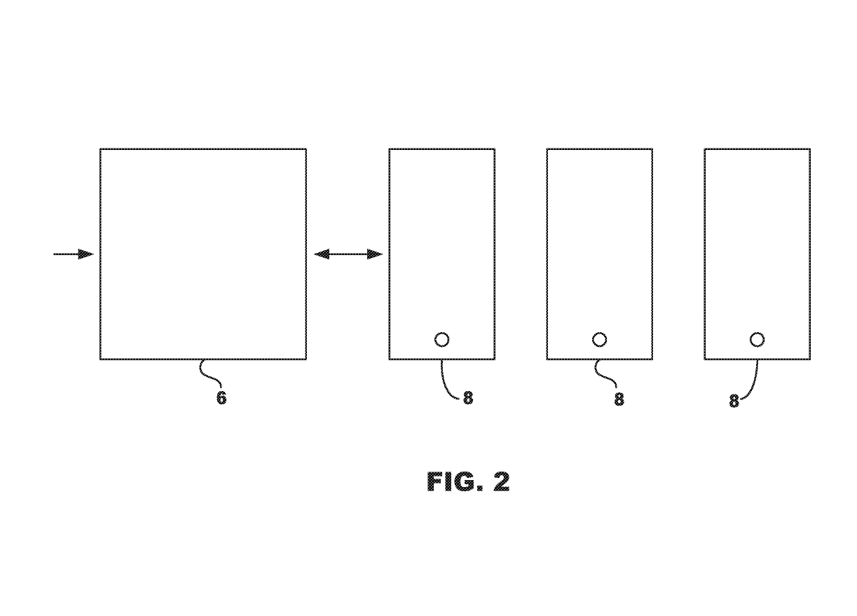

With reference to FIGS. 1 and 2, the features of the app according to the principles of the present disclosure will now be described. It should be understood that the app of the present disclosure can be implemented on a central computer server 6 and can communicate with a plurality of user devices 8 including e.g. smart phones, tablets or personal computers, best shown in FIG. 2. Although the emergency responder app is being described herein with reference to a personal smart phone or similar device, the present disclosure can also be implemented on a dedicated hand held device or vehicle mounted device that may or may not include other smart phone or similar features. Once the emergency responder app is downloaded to a user's smart phone or other device a login screen 10 can be utilized to login to the system for communication with the server in real time using credentials that can be authorized by administrative personnel. The login information can include an e-mail address 12 or phone number as well as a selected password 14. Once a user device 8 is logged in, an “Inactive Screen” 16 can be displayed on the user device 8. The “Inactive Screen” 16 can provide the user with the capability to for example, adjust their user profile via a button 18, view active calls via button 20 and indicate whether they are “on” or “off” duty via toggle button 22.

If the “Adjust Profile” button 18 is selected, an “Adjust Profile” screen 24 can be displayed on the user device 8. In the “Adjust Profile” screen 24, the user can update or change their name 26, address 28, phone number 30 and/or e-mail address 32 as needed using a pop-up key pad (not shown) on the screen or other external key pad. The user can also select an alert style 34 e.g. “vibrate”, “ring” or “strobe” or a combination thereof that will be used tom notify the user of an alert signal using the smart phone or other device's existing vibration unit, ringer or strobe warning devices.

If the “Active Calls” button 20 is selected, an “Active Calls” screen 36 can be displayed on the user device 8. The “active calls” screen 36 can display call details 38 e.g. the emergency type (fire, accident, medical, etc.) as well as location, status, information regarding people responding and real time information relating to each active emergency call. The “active calls” screen 36 can also include a “Change Response” button 40 that can allow the user to change their prior response to an alert. By way of example, an emergency responder who is responding to one active call may have selected “not responding” to another call and may change that response later after they have finished up activity on their previous call.

For any new alerts, a dispatcher receiving an emergency call can input pertinent information regarding the nature and details of the emergency call and the address location into a computer aided dispatcher server. The server then sends out an alert message with the relevant details to the subscribing user devices 8. The user devices 8 deciphers the call data and can display a “New Alert Screen” 50 that can be accompanied by the user's selected alert style (“vibrate”, “ring” or “strobe” or a combination thereof). The “New Alert Screen” 50 can display the call details 52 e.g. emergency type (fire, accident, medical, etc.) as well as address location, status, information regarding other users responding and other pertinent information relating to the new emergency call. It should be understood that due to space constraints on the user device, some of the information, e.g. call details, map info, etc., can be called up as a separate page at a touch of an icon/button. The address location information can be downloaded automatically into the user device's existing Maps app for instant access and/or for simultaneous display with the call details. The “New Alert Screen” can also include a series of response buttons 54a-c, e.g. “Not Responding” button 54a, “Responding” button 54b and “Responding with Equipment” button 54c. It should be understood that although the use of the terms “responding” or “not responding” are used herein, a literal use of these specific terms is not intended to be required. Instead, the terms are merely used to indicate whether the user has accepted or declined the alert message with an intent to respond or not to respond. By way of non-limiting example, a selection of the “Not Responding” button 54a, e.g. when the responder is involved with another call, can result in display of the “Inactive Screen” 16 on the user device. A selection of the “Responding” button 54b or the “Responding With Equipment” button 54c can result in the server updating a list of Responders (which will be described in further detail herein) to include the Responder's information and further resulting in the display of a “Map Info Page” screen 58 on the user's device 8.

The “Map Info Page” screen 58 can include the call details 52 e.g. the emergency type (fire, accident, medical, etc.) as well as the address location, status, information regarding other users responding and other pertinent information relating to the emergency call. The call details 52 can also be continually updated and displayed in real time as additional information is obtained. In addition, the “Map Info Page” 58 can include a map 60 showing the location of the emergency scene and including a route from the user's real time current location to the emergency scene, utilizing the user device's 8 existing map function. The user's real time location can be determined by the GPS function of the user's device 8 and can also be signaled back to the server and provided and displayed on a real time basis on a “Responders Location Map” which will be described in detail herein. In addition, a “Turn by Turn” button 61 can allow the user's device 8 to provide turn-by-turn driving instructions 64 for getting to the station or the emergency site using the smart phone or tablets existing map features. The selection of each user's map destination e.g. the station or the emergency site, can be determined by default, by a dispatcher, by a commander or by another team member, thereby eliminating any confusion as to where the user is intended to go. The “Map Info Page” screen 58 can also include a variety of additional option buttons 62a-62, e.g. an “Arrived On Scene” button 62a, a “Hydrant Location” button 62b, and an “Other Responders” button 62c.

Activation of the “Arrived On Scene” button 62a can result in a signal to the server to update the user's status as having arrived on scene, and further resulting in the display of an “Arrived on Scene” screen 66 on the user's device 8. The “Arrived on Scene” screen 66 can include a series of buttons 68a-68c e.g. including a “Closed Call” button 68a, a “Hydrant Location” button 68b and an “Other Responders” button 68c. It should be understood that other buttons may be provided for simply accessing other pertinent information, e.g. locations of known publicly accessible automated external defibrillators (AEDs) or other emergency equipment depending upon the specific field in which the app is being utilized. At the conclusion of the emergency response, the user can select the “Closed Call” button 68a that will return the user device to the “Inactive Screen” 16.

The selection of the “Hydrant Location” button 62b of the “Map Info Page” screen 58 or the “Hydrant Location” button 68b of the “Arrived On Scene” screen 66 will cause a localized map 70 to be displayed to illustrate to the user where the nearest fire hydrant(s) are located. The selection of the “Other Responders” button 62c of the “Map Info Page” screen 58 or the “Other Responders” button 68c of the “Arrived On Scene” screen 66 will result in the display of a real time map 72 displaying the location of the other Responders. This information is important for projecting when, e.g. a fire department crew can leave the fire station. In particular, a certain number of fire fighters are typically required for operating a fire truck either during transit or at the scene of a fire. Since each responder device is providing real time location feed back to the server, a commander or other team member can access the real time “Responders Location Map” to know approximately how long it will be until a sufficient number of responders will have arrived at the station. Once it is determined whether a necessary number of responders will be arriving at the station, the commander or other team member can re-direct some of the remaining responders via direct SMS text or voice messaging to go directly to the site or to provide other direct instruction by selecting the SMS message buttons 73. A commander's instruction to go directly to the site can also cause a default site address to be downloaded into the maps app of the user device so that the user is automatically rerouted by the maps app. The commander can also instruct individual responders to stand down by selection of the individual “Stand Down” buttons 74. This ability to assess the arrival times and easily communicate with each responder through direct communication greatly improves the response team's response time and efficiency.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A smart phone app system for use by emergency responders, comprising:
a server for processing and sending an alert signal indicating details of an emergency event to be displayed on an emergency responder's smart phone or other device and displaying input buttons for allowing the emergency responder to provide a response signal indicating that they are responding or they are not responding by touching one of the input buttons.

2. The smart phone app system according to claim 1, wherein the input buttons include a button that allows the emergency responder to indicate that they are responding with equipment directly to the emergency site.

3. The smart phone app system according to claim 1, wherein the server maintains a list of responders who have indicated they are responding to the emergency event and the list of responders is accessible on the emergency responder's smart phone or other device.

4. The smart phone app system according to claim 1, wherein the server provides collective information for generating a map screen illustrating the real time location of each of the responders that is accessible on the emergency responder's smart phone or other device.

5. The smart phone app system according to claim 1, wherein the server receives a response signal from each of the emergency responders responding to the emergency event and provides a responders screen listing the responders, the responders screen provides a communication option to allow the responders to communicate directly to each of the other responders responding to the emergency event.

6. The smart phone app system according to claim 1, wherein the server receives additional details and updates the details of the emergency event to be displayed on the responder's smart phone or other device after the initial emergency signal is sent.

7. The smart phone app system according to claim 1, wherein the server provides map information to the emergency responder's smart phone or other device for display of fire hydrant locations near an emergency scene.

8. The smart phone app system according to claim 1, wherein the server provides map information to the emergency responder's smart phone or other device for display of emergency equipment locations near an emergency scene.

9. A smart phone app system for use by emergency responders, comprising:
a server for processing and sending an emergency signal to an emergency responder's smart phone and including pertinent details of an emergency event including address information to be displayed in a map on the emergency responder's smart phone or other device for each emergency responder.

10. The smart phone app system according to claim 9, wherein the server maintains a list of responders who have indicated they are responding to the emergency event and the list of responders is accessible on the emergency responder's smart phone or other device.

11. The smart phone app system according to claim 9, wherein the server provides collective information for generating a map screen illustrating the real time location of each of the responders that is accessible on the emergency responder's smart phone or other device.

12. The smart phone app system according to claim 9, wherein the server receives a response signal from each of the emergency responders responding to the emergency event and provides a responders screen listing the responders, the responders screen provides a communication option to allow the responders to communicate directly to each of the other responders responding to the emergency event.

13. The smart phone app system according to claim 9, wherein the server receives additional details and updates the details of the emergency event to be displayed on the responders smart phone or other device after the initial emergency signal is sent.

14. The smart phone app system according to claim 9, wherein the server provides map information to the emergency responder's smart phone or other device for display of fire hydrant locations near an emergency scene.

15. The smart phone app system according to claim 9, wherein the server provides map information to the emergency responder's smart phone or other device for display of emergency equipment locations near an emergency scene.
